(19) United States
(12) Patent Application Publication
(10) Pub. No.: US 2024/0056928 A1
(43) Pub. Date: Feb. 15, 2024

(54) HANDOVER MANAGEMENT SERVICE

(71) Applicant: Verizon Patent and Licensing Inc., Basking Ridge, NJ (US)

(72) Inventors: Chin Chiu, Allen, TX (US); Chokri Trabelsi, Bridgewater, NJ (US); Anil Babu Vontikommu, Morris Plains, NJ (US); Asif Dawoodi Gandhi, Edison, NJ (US)

(21) Appl. No.: 17/819,032

(22) Filed: Aug. 11, 2022

(51) Int. Cl. H04W 36/30; H04W 36/00

(52) U.S. Cl. CPC H04W 36/30; H04W 36/0058

(57) ABSTRACT

A method, a network device, and a non-transitory computer-readable storage medium are described in relation to an handover management service. The handover management service may include receiving a measurement report from an end device. The measurement report may include an SINR value in combination with RSRP and/or RSRQ values. The measurement report may include values from a source cell, a candidate target cell, or both source and candidate target cells. The handover management service may determine whether to perform a handover, based on the measurement report in which a handover criteria does not include an RSRQ value. The handover management service may also determine whether to perform a handover based on handover criteria that includes a variable value for a threshold value. The variable value, among values, may be selected and correlated to a value included in the measurement report.

### BACKGROUND

Development and design of networks present certain challenges from a network-side perspective and an end device perspective. For example, Next Generation (NG) wireless networks, such as Fifth Generation New Radio (5G NR) networks are being deployed and under development.

### BRIEF DESCRIPTION OF THE DRAWINGS

FIG. 1 is a diagram illustrating an exemplary environment in which an exemplary embodiment of a handover management service may be implemented;

FIG. 2 is a diagram illustrating an exemplary process of an exemplary embodiment of the handover management service;

FIG. 3 is a diagram illustrating another exemplary process of an exemplary embodiment of the handover management service;

FIG. 4 is a diagram illustrating exemplary components of a device that may correspond to one or more of the devices illustrated and described herein;

FIG. 5 is a flow diagram illustrating an exemplary process of an exemplary embodiment of the handover management service; and

FIG. 6 is a flow diagram illustrating another exemplary process of an exemplary embodiment of the handover management service.

### DETAILED DESCRIPTION

The following detailed description refers to the accompanying drawings. The same reference numbers in different drawings may identify the same or similar elements. Also, the following detailed description does not limit the invention.

Measurement reports can be triggered at user equipment (UEs) based on reference signal received power (RSRP) values and reference signal received quality (RSRQ) values relative to certain events. For example, events may be defined by a standards body, such as Third Generation Partnership Project (3GPP), 3GPP2, International Telecommunication Union (ITU), European Telecommunications Standards Institute (ETSI), GSM Association (GSMA), and the like), such as A type of events, B type of events, and so forth. For example, an event A1 indicates that the serving cell becomes better than a threshold. According to exemplary implementation, event A1 may be expressed as MS−Hys>Thresh, in which MS is the measurement result of the serving cell, not considering any offsets, Hys is the hysteresis parameter for this event, and Thresh is the threshold parameter for this event. MS is expressed in decibel-milliwatts (dBm) in case of RSRP or in decibel (dB) in case of RSRQ, for example.

RSRP and signal-to-interference-plus-noise ratio (SINR) have large dB ranges relative to RSRQ, which is quite compressed in 4G systems. For example, a working compressed range for RSRQ is about 5 dB. As such, very small differences in RSRQ values (e.g., less than about 0.5 dB) may have to be acted upon to capture about a 4-5 dB difference in SINR in both 4G and 5G systems. Additionally, RSRQ is load and number of transmitter (Tx) antennas dependent and has a non-linear mapping to SINR. Thus, RSRQ may be an imprecise way to differentiate between acceptable and not acceptable SINR, such as in the downlink.

In a wireless network, diverse types of handovers may be implemented, such as inter-radio access technology (RAT), inter-frequency, and intra-frequency handovers (HO), which help provide and maintain suitable wireless service to end devices. A handover may be executed based on an RSRQ value included in a measurement report from a UE. A wireless station, such as an evolved Node B (eNB) or a next generation Node B (gNB), may determine whether or not to invoke an inter-frequency handover based on an inter-frequency handover criteria. As an example, suppose the inter-frequency handover criteria is expressed in terms of SINR, such as [Source_SINR<0 dB] and [Target_SINR>4 dB]. When applying RSRQ values where both source and target carriers are at about 50% load, and both the eNB cells are 4Tx, the corresponding inter-frequency handover criteria works out as [Source_RSRQ<−16 dB] and [Target_RSRQ>−14.5 dB]. That is, the SINR difference value (e.g., about 4 dB) gets compressed to an RSRQ difference value (e.g., about 1.5 dB). As a consequence, the compressed scale associated with RSRQ relative to SINR, can lead to excessive handovers (e.g., ping-ponging back and forth between different cells), for example. According to other examples and configurations, before an inter-frequency handover may even take place, the radio frequency (RF) may degrade to an SINR value that would cause a call to drop, for example.

According to exemplary embodiments, a handover management service is described. According to various exemplary embodiments, the handover management service may pertain to an inter-RAT handover, an inter-frequency handover, and/or an intra-frequency handover (referred to herein as a “handover”). According to various exemplary embodiments, the handover management service may pertain to various RATs, such as 5G, Fourth Generation (4G), and/or a future generation RAT (e.g., 5.5G, Sixth Generation (6G), Seventh Generation (7G), etc.). According to various exemplary embodiments, the handover management service may apply to various types of triggering events (e.g., A type of events, B type of events, and other types of events which may pertain to a handover procedure) defined by a standards body (e.g., 3GPP, 3GPP2, ETSI, etc.) in which such events may be implemented with modification (in whole or in part) according to an embodiment of the handover management service.

According to an exemplary embodiment, the handover management service determines when to perform a handover based on an SINR value and not an RSRQ value, even when a measurement report trigger and/or a measurement report may include an RSRQ value or an RSRQ value and an RSRP value, for example. According to various exemplary embodiments, the measurement report may include an SINR value in combination with an RSRQ value and/or an RSRP value. According to various exemplary embodiments, the measurement report may include measured values (e.g., SINR, RSRQ, RSRP, etc.) that relate to a source cell, a (candidate) target cell, or both source and target cells.

According to an exemplary embodiment of the handover management service, a wireless station of a radio access network may determine, based on the measurement report, whether to perform the handover. According to an exemplary embodiment, the wireless station may apply a handover criteria, which may include use of the SINR value, as described herein.

In addition to the above, other issues pertaining to a handover remain. For example, typically, triggering events for measurement reports and other types of criteria (e.g., handover criteria, etc.) may include a fixed threshold value (e.g., source>threshold, source<threshold, target<threshold, etc.) or a fixed delta value (e.g., target−source). However, such a configuration can yield undesirable results in which the wireless station may not invoke a handover due to the fixed threshold or delta values or conversely, invoke a handover. For example, suppose a source SINR is at about 3 dB. It may not be beneficial to switch to a target cell that has an SINR which is about 2 dB better because this may lead to a ping-ponging effect and going to a carrier with a slightly better RF compared to the already existing one. However, if the target cell has an SINR which is about 5 dB or more, performance of a handover may be beneficial. On the other hand, according to another example, suppose a source SINR is about −3 dB. In this case, a target cell with a 2 dB better SINR may be worth switching to so as to avoid or minimize a potential dropped connection. Further, a target SINR of about +5 dB or more improvement (e.g., relative to the −3 dB) may never occur and/or not be available. In this regard, the application of a handover criteria using a fixed threshold value and/or a fixed delta value may lead to sub-optimal connectivity between the wireless station and the end device, performance issues, and waste of network resources, as described herein. For example, the triggering event may pertain to a handover triggering event and/or a measuring report triggering event.

According to an exemplary embodiment, the handover management service may use a variable SINR, RSRP, and/or RSRQ value(s) as criteria, as described herein. For example, the criteria may pertain to a handover criteria and/or a measurement report criteria. According to an exemplary embodiment, the variable value may be implemented as a variable threshold value or a variable delta value. According to an exemplary embodiment, the variable value may be a source variable value and/or a target variable value, such as a source variable SINR value, a target variable SINR value, and so forth. For example, according to an exemplary expression ((target SINR−source SINR)>variable threshold value), the variable threshold value may be dependent upon the source SINR in which one source SINR value or range of source SINR values may map to a first variable (SINR) threshold value, while a different source SINR value or range of source SINR values may map to a second variable (SINR) threshold value. This is in contrast to a fixed threshold value in which the same fixed threshold value would apply regardless of the values for source and/or target values.

In view of the foregoing, the handover management service may prevent or minimize excessive handovers between source and target cells, may improve downlink performance (e.g., in terms of throughput, bitrate, reliability, etc.), may prevent or minimize connection drops, and may provide more reliable handovers.

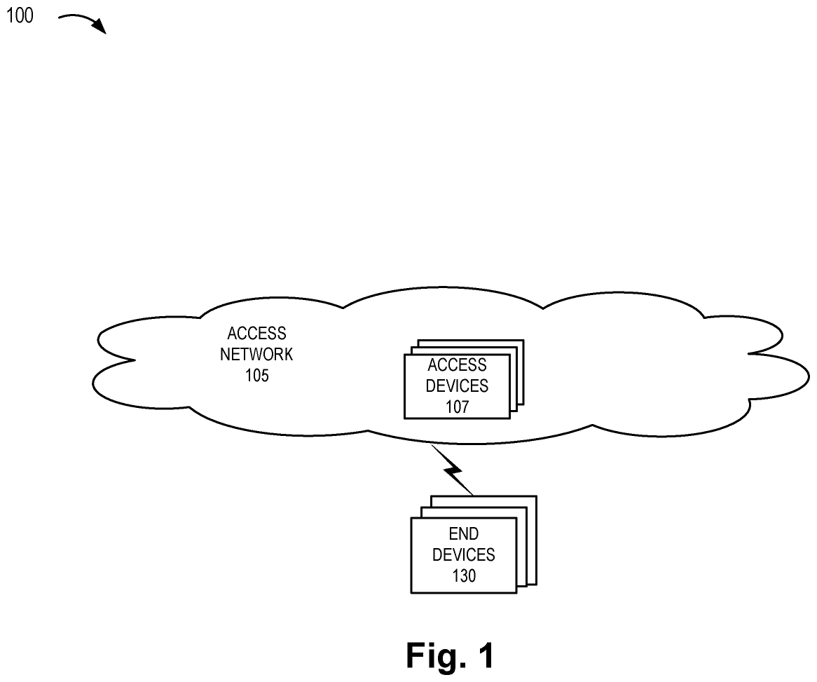

FIG. 1 is a diagram illustrating an exemplary environment 100 in which an exemplary embodiment of handover management service may be implemented. As illustrated, environment 100 includes an access network 105. Access network 105 includes access devices 107 (also referred to individually or generally as access device 107). Environment 100 further includes end devices 130 (also referred to individually or generally as end device 130).

The number, type, and arrangement of network illustrated in environment 100 are exemplary. For example, according to other exemplary embodiments, environment 100 may include additional networks and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), a core network, a multi-access edge computing (MEC) network, or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, network slice, etc.). The number, the type, and the arrangement of network devices are exemplary.

Environment 100 includes communication links between network devices, between a network and an end device, and so forth. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. According to various exemplary implementations, the interface of a device may be a service-based interface, a reference point-based interface, an Open Radio Access Network (O-RAN) interface, a 5G interface, a 4G interface, or another generation of interface (e.g., 5.5G interface, a 6G interface, a 7G interface, etc.), or some other type of network interface.

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and a core network including an Evolved Packet Core (EPC) network and/or an NG core (NGC) network (not illustrated), or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of cell architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a gNB, an evolved Long Term Evolution (eLTE) evolved Node B (eNB), an eNB, a radio network controller (RNC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), another type of wireless node (e.g., a WiFi device, a WiMax device, a hotspot device, etc.) that provides a wireless access service, or another type of network device that provides a transport service (e.g., routing and forwarding), such as a router, a switch, or another type of layer 3 (e.g., network layer of the Open Systems Interconnection (OSI) model) network device. Additionally, or alternatively, access device 107 may include a wired and/or optical device (e.g., modem, wired access point, optical access point, Ethernet device, etc.) that provides network access. According to some exemplary implementations, access device 107 may include a combined functionality of multiple RATs (e.g., 4G and 5G functionality, 5G and 5.5G functionality, etc.) via soft and hard bonding based on demands and needs. According to some exemplary implementations, access device 107 may include an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), tow dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector, carrier, and/or other configurable level.

According to an exemplary embodiment, at least some of access devices 107 include logic of the handover management service, as described herein. For example, access device 107 may receive a measurement report from end device 130. According to an exemplary embodiment of the handover management service, access device 107, in response to receiving the measurement report, may determine whether to perform or invoke a handover procedure. According to an exemplary embodiment, access device 107 may determine when to perform a handover based on an SINR value and not an RSRQ value, even when a measurement report trigger and/or a measurement report may include an RSRQ value or an RSRQ value and an RSRP value, for example. According to an exemplary embodiment, a handover criteria may not include the use of the RSRQ value.

According to an exemplary embodiment, additionally or alternatively, access device 107 may use a variable SINR, RSRP, and/or RSRQ value(s) as criteria, as described herein. According to an exemplary embodiment, the variable value may be implemented as a variable threshold value or a variable delta value. According to an exemplary embodiment, the variable value may be or relate to a source variable value or a target variable value. According to an exemplary embodiment, access device 107 may perform a lookup procedure or computation to identify a value for the variable value, as described herein. For example, access device 107 may store data that correlates source and/or target values to variable threshold or delta values of a handover criteria. According to an exemplary embodiment, access device 107 may select a value included in the measurement report to perform the lookup procedure and select the appropriate variable value. According to another exemplary embodiment, access device 107 may calculate the appropriate variable value based on the value included in the measurement report. Access device 107 may determine whether to invoke or perform a handover based on the use of the variable value in a handover criteria.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a phablet, a wearable device (e.g., a watch, glasses, etc.), a computer, a gaming device, a music device, an Internet of Things (IoT) device, a drone, a smart device, a sensor, an automated guided vehicle (AGV), an industrial robot, or other type of wireless device (e.g., other type of UE). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device.

According to an exemplary embodiment, end device 130 may include logic of the handover management service. According to an exemplary embodiment, end device 130 may be configured by access device 107 in relation to the value(s) included in a measurement report. According to various exemplary embodiments, end device 130 may include in the measurement report, when a measurement report trigger event is satisfied, an SINR value in combination with an RSRQ value and/or an RSRP value. According to various exemplary embodiments, the measurement report may include measured values (e.g., SINR, RSRQ, RSRP, etc.) that relate to a source cell, a (candidate) target cell, or both source and target cells.

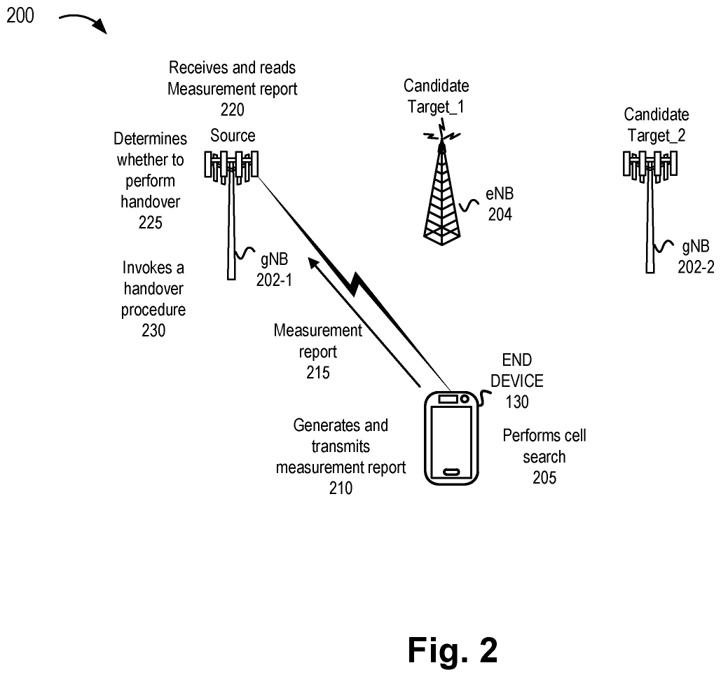

FIG. 2 is a diagram illustrating an exemplary process 200 of an exemplary embodiment of the handover management service according to an exemplary scenario. As illustrated, process 200 may be implemented in an environment that includes end device 130 and access devices 107 (e.g., a gNB 202-1, a gNB 202-2, and an eNB 204). As described in relation to FIG. 1, according to other exemplary embodiments, the environment may include another type of access device 107 not specifically illustrated and described in FIG. 2. As such, process 200 may be implemented by another type of access device 107.

Referring to FIG. 2, assume that a wireless connection (e.g., a radio resource control (RRC) connection) has been established between end device 130 and gNB 202-1. Subsequently, end device 130 may be triggered to perform a cell search based on a search trigger. For example, the event may relate to current RSRQ, RSRP, and/or SINR values associated with a source cell or frequency of gNB 202-1 to which end device 130 is connected. End device 130 may perform the cell search 205 including obtaining downlink measurements relating to cells of eNB 204 and gNB 202-2. The downlink measurements may include RSRQ, RSRP, and/or SINR values. Based on a measurement report criteria, according to this exemplary scenario, end device 130 generates and transmits 210 a measurement report to gNB 202-1. According to an exemplary embodiment, a measurement report 215 includes SINR values in combination with RSRP and/or RSRQ values relating to source cell (e.g., gNB 202-1) and, candidate target cell 1 and/or candidate target cell 2 (e.g., gNB 202-2 and/or eNB 204).

As further illustrated in FIG. 2, gNB 202-1 may receive and read 220 the measurement report, and determine whether to perform a handover 225. According to an exemplary embodiment, gNB 202-1 may make this determination based on a handover criteria. According to various exemplary embodiments, the handover criteria may include the SINR values and the RSRP values included in measurement report 215. According to an exemplary scenario, gNB 202-1 may determine to invoke a handover procedure 230 based on the handover criteria, as illustrated. For example, gNB 202-1 may determine to perform a handover relative to eNB 204 and/or gNB 202-2. According to other exemplary scenarios, although not illustrated, gNB 202 may determine to not invoke/perform the handover procedure.

The messages and operations illustrated and described are exemplary. According to other exemplary embodiments, process 200 may include additional and/or different messages not specifically described and illustrated. According to other exemplary embodiments and scenarios, process 200 may include additional operations, fewer operations, and/or different operations that may be performed.

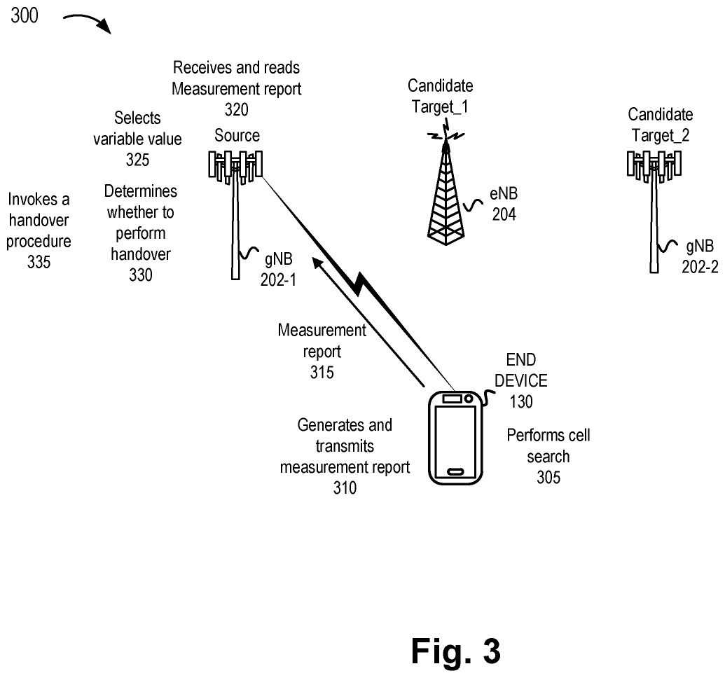

FIG. 3 is a diagram illustrating an exemplary process 300 of an exemplary embodiment of the handover management service according to an exemplary scenario. As illustrated, process 300 may be implemented in an environment that includes end device 130 and access devices 107 (e.g., gNB 202-1, gNB 202-2, and eNB 204). As described in relation to FIG. 1, according to other exemplary embodiments, the environment may include another type of access device 107 not specifically illustrated and described in FIG. 3.

Referring to FIG. 3, operations/steps 305-320 of process 300 may be the same as or substantially similar to steps/operations 205-220 of process 200 illustrated in FIG. 2 and described herein. As such, for the sake of brevity, steps 305-320 will not described again. However, as further illustrated, in response to receiving and reading 320 the measurement report, gNB 202-1 may select 325 a variable value in relation to a handover criteria. For example, the handover criteria may include a variable threshold value. By way of further example, the variable threshold value may be implemented in various ways or expressions, such as one of Source value>variable threshold value, Source value<variable threshold value, Target value>variable threshold value, Target value<variable threshold value, Source value>variable threshold value, and so forth. According to an exemplary embodiment, in view of the exemplary expressions mentioned, the source value, the target value, and the variable threshold value may relate to an SINR value, an RSRP value, or a combination of such values. For example, the handover criteria may include a combination of such values, such as (Source SINR<Variable Source SINR threshold) and (Target RSRP>Variable Target RSRP threshold). According to another example, the handover criteria may include another combination of such values, such as (Source SINR<Variable Source SINR threshold) and (Target SINR>Variable Target SINR threshold) and (Target RSRP>Variable Target RSRP threshold).

According to another exemplary embodiment, the variable value in relation to the handover criteria may include a variable delta value. For example, the variable delta value may be implemented in several ways or expressions, such as (Target value−Source value)>Variable delta value, (Source value−Target Value)<Variable delta value, and so forth. Similar to that explained in relation to the variable threshold value, the variable delta value may relate to an SINR value, an RSRP value, or a combination of such values. For example, the handover criteria may include a combination of such values, such as (Target SINR value−Source SINR value)>Variable delta SINR value and (Target RSRP value−Source RSRP value)>Variable delta RSRP value.

According to an exemplary embodiment, access device 107, such as gNB 202-1 may perform a lookup to determine a value for the variable value. According to an exemplary embodiment, access device 107 may store handover service management service information that correlates values for a variable threshold value and/or a variable delta threshold value to source and/or target values of like measured type values, as described herein. According to an exemplary embodiment, access device 107 may identify the type of variable value (based on a reading of the handover criteria) and perform a lookup based on the type of variable value. According to another exemplary embodiment, access device 107 may calculate the value for the variable threshold value or the variable delta threshold value.

According to an exemplary embodiment, the handover management service information may include multiple values (e.g., two or more) for a variable value depending on a comparative value applied to the variable threshold value. For example, an exemplary handover criteria expressed as Source SINR<Variable Source SINR threshold, the Variable Source SINR threshold value may be different depending on the comparative value of the Source SINR (e.g., included in the measurement report). By way of further example, if the Source SINR value is 5 dB or within a range of 5 dB-10 dB, the Variable Source SINR threshold value may be X dB. However, according to another example, if the Source SINR value is 10 dB or within a range of 10 dB-13 dB, the Variable Source SINR threshold value may be Y dB in which Y dB may be a different value than X dB. In this regard, the SINR range may be divided into different sub-ranges and/or single SINR value(s) in which the Variable Source SINR threshold value is not the same or fixed regardless of the Source SINR value, but may have different values depending on a correlated or mapped Source SINR to which the Variable Source SINR threshold value is compared.

According to another example, an exemplary handover criteria expressed as (Target SINR value−Source SINR value)>Variable delta SINR threshold value, the Variable delta SINR threshold value may depend on the Source SINR value, the Target SINR value, or both values. According to such an exemplary embodiment, the handover management service may correlate or map different Variable delta SINR threshold values to different values associated with one or multiple comparative values (e.g., Target SINR value, Source SINR value, etc.) depending on the handover criteria, or vice versa (e.g., different comparative values correlate or map to different Variable delta SINR threshold values, and so forth. The variable values may relate to SINR and/or RSRP. According to other examples, the variable values may relate to other types of measured and/or calculated values, such as RSRQ, received signal strength indicator (RSSI), and/or other types of reference signal measurements associated with a RAT and pertaining to end device 130 and access device 107, which may be specified in a wireless standard (e.g., 3GPP, ETSI, etc.) and/or of a proprietary nature. According to various exemplary embodiments, the comparative value included in the handover management service information include various entries in which the correlation may relate to a singular comparative value (e.g., Source SINR=5 dB) or range of values (e.g., for Source SINRs in the range between 2-5 dB) that may be correlated to variable threshold value. According to other exemplary embodiments, access device 107 may calculate the variable value based on the comparative value(s).

As further illustrated, based on the selection of a value for the variable value, gNB 202-1 may determine whether to invoke/perform a handover 330. For example, gNB 202 may apply the handover criteria with the look-up/calculated value(s) and values included in the measurement report and determine whether the handover criteria have been satisfied or not. According to this exemplary scenario, assume that the handover criteria has been satisfied, and in response, gNB may invoke or perform a handover procedure 335. According to other exemplary scenarios, this may not be the case, as previously described.

The messages and operations illustrated and described are exemplary. According to other exemplary embodiments, process 300 may include additional and/or different messages not specifically described and illustrated. According to other exemplary embodiments and scenarios, process 300 may include additional operations, fewer operations, and/or different operations that may be performed.

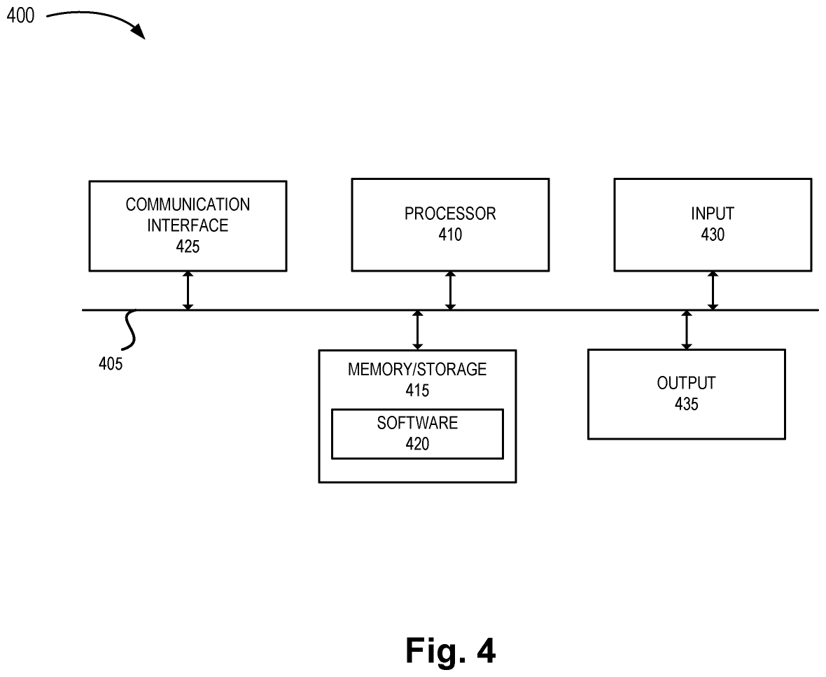

FIG. 4 is a diagram illustrating exemplary components of a device 400 that may be included in one or more of the devices described herein. For example, device 400 may correspond to access device 107, end device 130, gNB 202, eNB 204, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to access device 107, software 420 may include an application that, when executed by processor 410, provides a function and/or a process of handover management service, as described herein. Additionally, for example, with reference to end device 130, software 420 may include an application that, when executed by processor 410, provides a function and/or a process of handover management service, as described herein. Software 420 may also include firmware, middleware, microcode, hardware description language (HDL), and/or other form of instruction. Software 420 may also be virtualized. Software 420 may further include an operating system (OS) (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, etc.). Device 400 may be implemented in the same manner. For example, device 400 may be instantiated, created, deleted, or some other operational state during its life-cycle (e.g., refreshed, paused, suspended, rebooting, or another type of state or status), using well-known virtualization technologies. For example, access device 107 and/or end device 130, as described herein, may be a virtualized device.

Device 400 may perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a function or a process described herein. Alternatively, for example, according to other implementations, device 400 performs a function or a process described herein based on the execution of hardware (processor 410, etc.).

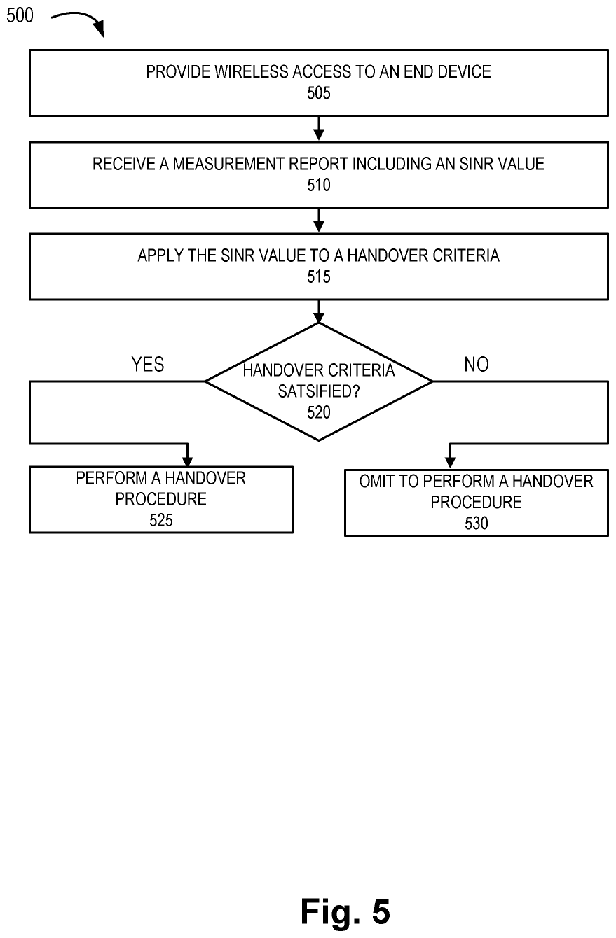

FIG. 5 is a flow diagram illustrating an exemplary process 500 of an exemplary embodiment of the handover management service. According to an exemplary embodiment, access device 107 may perform a step of process 500. According to an exemplary implementation, processor 410 executes software 420 to perform a step of process 500, as described herein. Alternatively, a step may be performed by execution of only hardware.

In block 505, access device 107 may provide wireless service to end device 130. For example, end device 130 may be attached to access device 107 or camped on a cell of access device 107 based on the completion of an RRC procedure. End device 130 may or may not be registered/attached to or connected to a core network, an application service layer network (e.g., a MEC network, the Internet, a cloud network, etc.), or another type of network.

In block 510, access device 107 may receive a measurement report that includes an SINR value. For example, based on a measurement report triggering event occurring at end device 130, end device 130 may generate and transmit the measurement report to access device 107. According to various exemplary embodiments, the measurement report may include measured and/or calculated values, as described herein, such as an SINR value in combination with an RSRP value and/or an RSRQ value.

In block 515, access device 107 may apply the SINR value to a handover criteria. For example, the handover criteria may not use an RSRQ value. Rather, according to various implementations, the handover criteria may use the SINR value and an RSRP value, as described herein. Access device 107 may apply a value included in the measurement report to the handover criteria.

In block 520, access device 107 may determine whether the handover criteria is satisfied. For example, access device 107 may determine a result of the handover criteria based on the values applied to the handover criteria.

When it is determined that the handover criteria is satisfied (block 520-YES), access device 107 may perform a handover procedure (block 525). For example, a source access device may perform a handover with end device 130 and a target access device. When it is determined that the handover criteria is not satisfied (block 520-NO), access device 107 may omit to perform a handover procedure (block 530).

FIG. 5 illustrates an exemplary process of the handover management service, according to other exemplary embodiments, the handover management service may perform additional operations, fewer operations, and/or different operations than those illustrated and described.

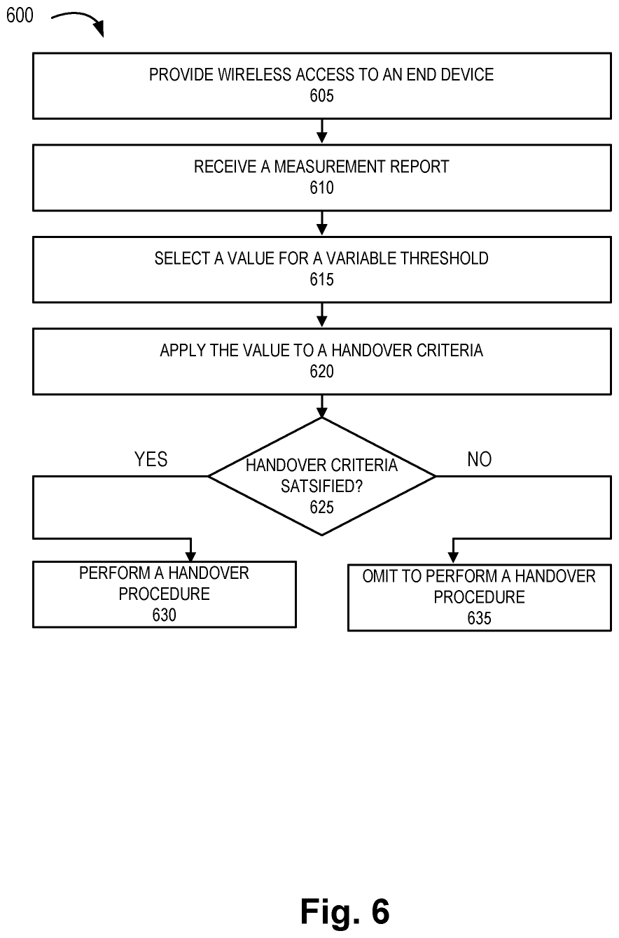

FIG. 6 is a flow diagram illustrating another exemplary process 600 of an exemplary embodiment of the handover management service. According to an exemplary embodiment, access device 107 may perform a step of process 600. According to an exemplary implementation, processor 410 executes software 420 to perform a step of process 600, as described herein. Alternatively, a step may be performed by execution of only hardware.

In block 605, access device 107 may provide wireless service to end device 130. For example, end device 130 may be attached to access device 107 or camped on a cell of access device 107 based on the completion of an RRC procedure. End device 130 may or may not be registered/attached to or connected to a core network, an application service layer network (e.g., a MEC network, the Internet, a cloud network, etc.), or another type of network.

In block 610, access device 107 may receive a measurement report. For example, based on a measurement report event occurring at end device 130, end device 130 may generate and transmit the measurement report to access device 107. According to various exemplary embodiments, the measurement report may include measured and/or calculated values, as described herein, such as an SINR value in combination with an RSRP value and/or an RSRQ value. Alternatively, the measurement report may include only an RSRP value or other types of values, as described herein.

In block 615, access device 107 may select a value for a variable threshold. For example, access device 107 may perform a lookup and select a value for a variable threshold value or a delta variable threshold value, as described herein. Access device 107 may store handover management service information, as described herein. Alternatively, access device 107 may calculate the variable threshold value or the delta variable threshold value.

In block 620, access device 107 may apply the value to the handover triggering criteria. For example, access device 107 may use the selected or calculated value and one or more values included in the measurement report, as described herein.

In block 625, access device 107 may determine whether the handover criteria is satisfied. For example, access device 107 may determine a result of the handover criteria.

When it is determined that the handover criteria is satisfied (block 625-YES), access device 107 may perform a handover procedure (block 630). For example, a source access device may perform a handover with end device 130 and a target access device. When it is determined that the handover criteria is not satisfied (block 625-NO), access device 107 may omit to perform a handover procedure (block 635).

FIG. 6 illustrates an exemplary process of the handover management service, according to other exemplary embodiments, the handover management service may perform additional operations, fewer operations, and/or different operations than those illustrated and described.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive. For example, the handover management service may include management of radio connections relative to dual connectivity or higher scenarios in relation to master cells, secondary cells, and so forth, which may include releases, handover, and/or similar operations.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks have been described regarding the processes illustrated in FIGS. 5 and 6, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device from an end device, a measurement report;
selecting, by the network device in response to the receiving and based on the measurement report, a first value from multiple values for a variable threshold value included in handover criteria;
applying, by the network device in response to the selecting, the first value to the handover criteria; and
determining, by the network device in response to the applying, whether to perform a handover of the end device.

2. The method of claim 1, wherein the first value is selected based on a correlation with a second value included in the measurement report.

3. The method of claim 1, wherein the first value pertains to a signal-to-interference-plus noise ratio (SINR) or a reference signal received power (RSRP).

4. The method of claim 1, wherein the first value pertains to a difference value between a source cell value and a target cell value.

5. The method of claim 1, wherein the handover pertains to an inter-frequency handover, an intra-frequency handover, or an inter-radio access technology (RAT) handover.

6. The method of claim 1, further comprising:
determining, by the network device, that the handover criteria is satisfied; and
performing, by the network device, the handover.

7. The method of claim 1, further comprising:
applying, by the network device, one or more values included in the measurement report to the handover criteria.

8. The method of claim 1, wherein the network device is a next generation Node B (gNB), an evolved Node B (eNB), or an evolved Long Term Evolution (eLTE) eNB.

9. A network device comprising:
a processor that is configured to:
receive, from an end device, a measurement report;
select, based on the measurement report, a first value from multiple values for a variable threshold value included in handover criteria;
apply the first value to the handover criteria; and
determine whether to perform a handover of the end device.

10. The network device of claim 9, wherein the first value is selected based on a correlation with a second value included in the measurement report.

11. The network device of claim 9, wherein the first value pertains to a signal-to-interference-plus noise ratio (SINR) or a reference signal received power (RSRP).

12. The network device of claim 9, wherein the first value pertains to a difference value between a source cell value and a target cell value.

13. The network device of claim 9, wherein the handover pertains to an inter-frequency handover, an intra-frequency handover, or an inter-radio access technology (RAT) handover.

14. The network device of claim 9, wherein the processor is further configured to:
determine that the handover criteria is satisfied; and
perform the handover.

15. The network device of claim 9, wherein the processor is further configured to:
apply one or more values included in the measurement report to the handover criteria.

16. The network device of claim 9, wherein the network device is a next generation Node B (gNB), an evolved Node B (eNB), or an evolved Long Term Evolution (eLTE) eNB.

17. A non-transitory computer-readable storage medium storing instructions executable by a processor of a network device, wherein the instructions are configured to:
receive, from an end device, a measurement report;
select, based on the measurement report, a first value from multiple values for a variable threshold value included in handover criteria;
apply the first value to the handover criteria; and
determine whether to perform a handover of the end device.

18. The non-transitory computer-readable storage medium of claim 17, wherein the first value is selected based on a correlation with a second value included in the measurement report.

19. The non-transitory computer-readable storage medium of claim 17, wherein the first value pertains to a signal-to-interference-plus noise ratio (SINR) or a reference signal received power (RSRP).

20. The non-transitory computer-readable storage medium of claim 17, wherein the instructions further comprise instructions configured to:
determine that the handover criteria is satisfied; and
perform the handover.
